(19) United States
(12) Patent Application Publication
(10) Pub. No.: US 2018/0264722 A1
(43) Pub. Date: Sep. 20, 2018

(54) MARKING BUILD MATERIAL

(71) Applicant: HEWLETT-PACKARD DEVELOPMENT COMPANY, L.P., Houston, TX (US)

(72) Inventors: Sergio Puigardeu Aramendia, Barcelona (ES); Pol Fornos, Sant Cugat del Valles (ES); David Ramirez Muela, Barcelona (ES); Salvador Sanchez Ribes, Sabadell (ES)

(73) Assignee: HEWLETT-PACKARD DEVELOPMENT COMPANY, L.P., Houston, TX (US)

(21) Appl. No.: 15/542,633

(22) PCT Filed: Apr. 14, 2015
(86) PCT No.: PCT/EP2015/058075

§ 371 Date: Jul. 10, 2017

(51) Int. Cl. B29C 64/165; B29C 64/357; B29C 64/393

(52) U.S. Cl. CPC B29C 64/165; B22F 3/008; B29C 64/393; B29C 64/357

(57) ABSTRACT

According to one example, there is provided a method of 3D printing. The method comprises generating, within a volume of build material, a volume of solidified build material, and marking a predetermined portion of unsolidified build material within the build volume with a marking agent.

### BACKGROUND

Additive manufacturing techniques, such as 3D printing, enable objects to be generated on a layer-by-layer basis. 3D printing techniques may generate a layer of an object by selectively solidifying a portion of a layer of a build material.

### BRIEF DESCRIPTION

Examples will now be described, by way of non-limiting example only, with reference to the accompanying drawings, in which:

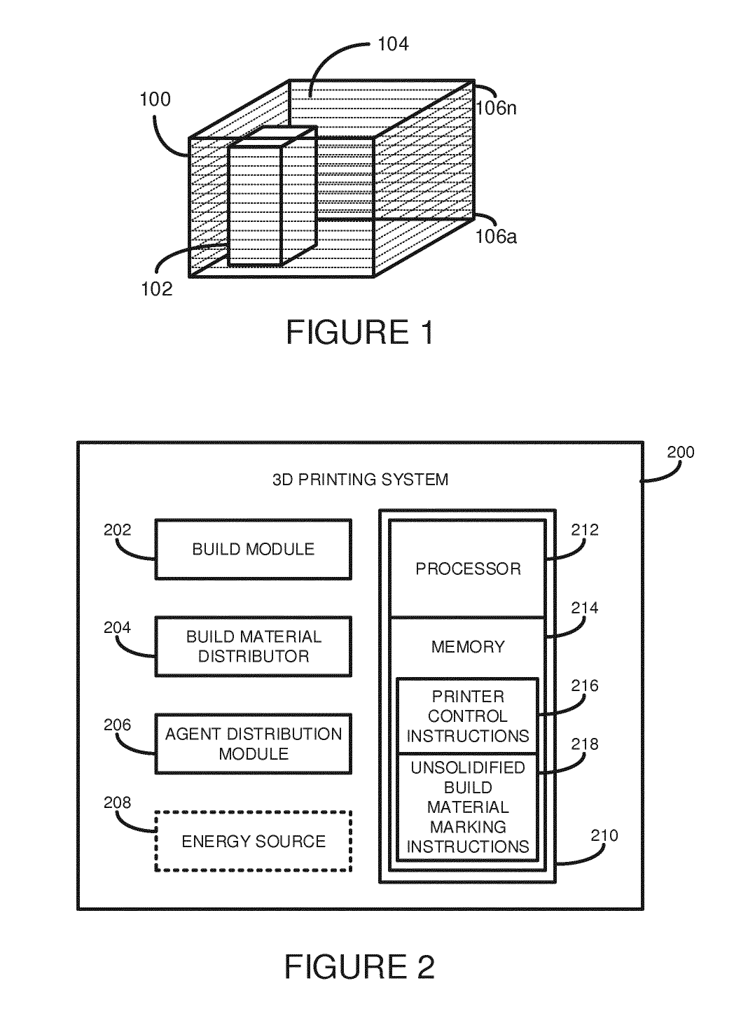

FIG. 1 is an illustration of a build volume according to one example;

FIG. 2 is a block diagram of a 3D printing system according to one example;

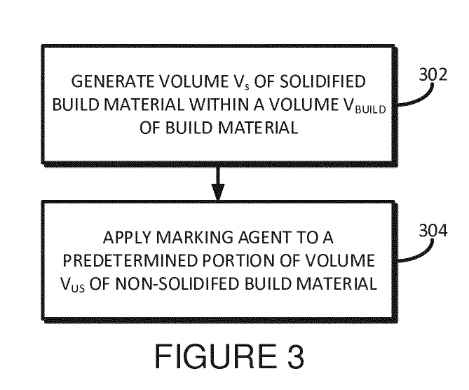

FIG. 3 is a flow diagram outlining a method of operating a 3D printing system according to one example;

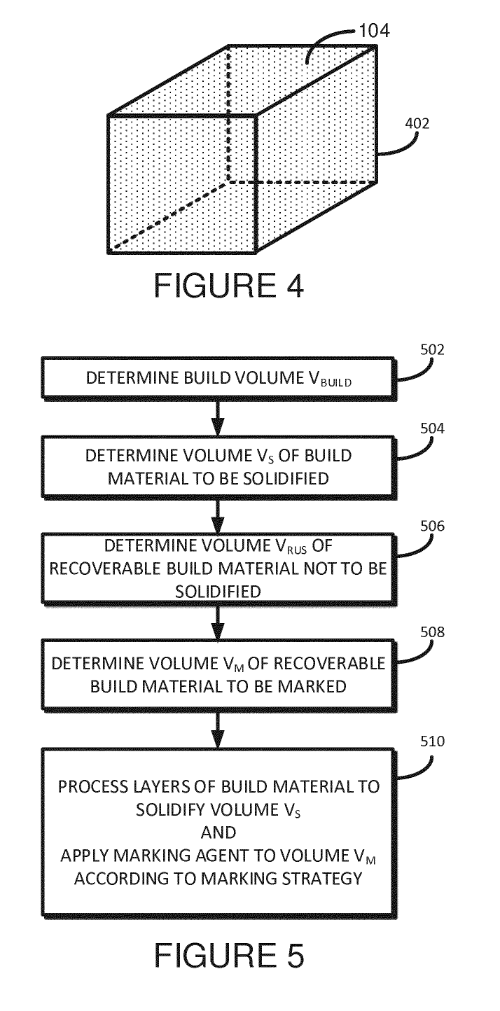

FIG. 4 is an illustration of a volume of unsolidified build material according to one example;

FIG. 5 is a flow diagram outlining a method of operating a 3D printing system according to one example;

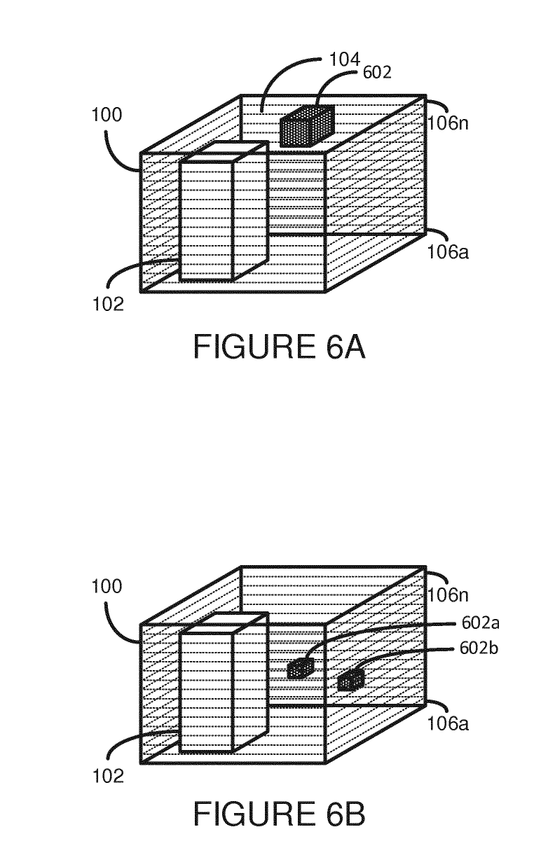

FIG. 6A and FIG. 6B are illustrations of a build volume to which a marking agent has been applied according to examples; and

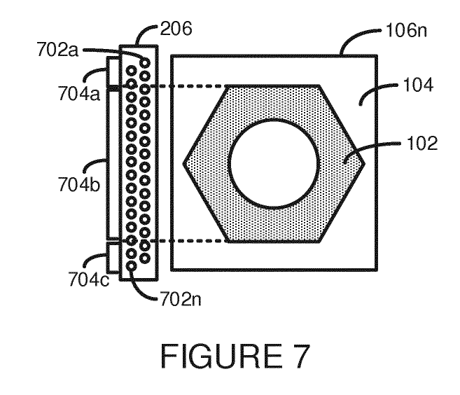

FIG. 7 is a plan view of a portion of a 3D printing system according to one example.

### DETAILED DESCRIPTION

The economic and environmental cost of 3D printing may be lowered through effective reuse of build material that is used during a 3D printing process but that is not solidified. The term 3D printing is used herein to refer to any suitable additive manufacturing process.

The term ‘build material’, as used herein, refers to any material suitable for use by a 3D printing system to generate 3D objects. The term ‘build material’ is used herein generally to refer to unsolidified build material. The exact nature of the build material may be chosen based on criteria that may include, for example: the solidification mechanism used by the 3D printing technique used; and the properties of a generated 3D object.

In some examples build material may be in the form of a dry powder. In other examples the build material may be in the form of a paste, a gel, a slurry, or the like. Common powder-based build materials may include nylon-12, plaster, and metals.

Some 3D printing techniques selectively solidify portions of a layer of build material by selectively printing a coalescing agent on the layer of build material in a pattern corresponding to a layer of the object being generated, and applying energy to the whole, or a substantial portion, of the layer of build material. Those portions of the build material on which coalescing agent is deposited absorb sufficient energy to cause the temperature of those portions to rise such that coalescence, and subsequent solidification, occurs. Those portions of the build material on which no coalescing agent is deposited do not absorb sufficient energy to cause coalescence, and hence do not solidify.

Such 3D printing techniques may be highly efficient and thus may enable 3D objects to be generated rapidly.

Other types of 3D printing techniques also exist and the examples described herein may not be limited to the example 3D printing techniques described herein. For example, some variant 3D printing techniques may apply a coalescing agent to layers of a build material without applying energy to each layer of build material, and may apply energy to the whole build volume once coalescing agent has been applied to different ones of the layers in the build volume.

Build material which is not solidified during a 3D printing process will have received an amount of energy and hence may have undergone physical changes as a result of the energy received, even though the amount of energy received was not sufficient to cause the build material to coalesce and solidify. Unsolidified build material may thus have different properties, such as different physical or mechanical properties, compared to fresh build material that has not previously been used in a 3D printing process.

Since the properties of a generated 3D object may be influenced by the properties of the build material used, there is a balance to be found between generating high quality 3D printed objects using ‘fresh’ build material and reducing 3D printing costs through re-use of unsolidified build material.

Unsolidified build material may be mixed with other build material, such as fresh build material, to form a build material mix that has acceptable properties for use in subsequent 3D printing processes. For example, forming a mix of previously used unsolidified build material and fresh build material may enable a build material mix to be formed at a lower cost than using just fresh build material.

Examples described herein provide techniques to enable unsolidified build material that has been previously used in a 3D printing process to be reused in subsequent 3D printing processes, by combining it with a determined quality of a different build material, such as fresh, or ‘fresher’ build material.

Referring now to FIG. 1, there is shown an illustration of the contents of a 3D printing system build module, hereinafter referred to as a build volume 100, after a 3D printing process has been performed by a 3D printing system. For clarity the build module itself is not shown, however the build module may be a suitable container in which a 3D printing system may generate a 3D object. For example, the build module may include side walls and a movable floor. A 3D printing system may form successive layers 106a to 106n of build material on and above the movable floor and may selectively solidify portions thereof to generate a 3D object, for example in the manner described above. The thickness of each layer of build material may vary depending on the type of 3D printing system used and configuration parameters, but may in some examples be in the region of about 50 to 200 um.

Once a 3D printing process has been completed the build volume, V_{BUILD}, 100 comprises a volume, V_{S}, 102 of solidified build material, and a volume, V_{US}, 104 of unsolidified build material that was not solidified during the 3D printing process. In the example shown a single volume of solidified build material is shown, although in other examples the volume V_{S} of solidified build material may comprise separate sub-volumes of solidified build material, for example as result of multiple 3D objects being generated within the build volume 100.

As previously mentioned, the volume V_{US} 104 of unsolidified build material in the build volume 100 may have undergone physical or mechanical changes as a result of the 3D printing processes performed, and may thus have different properties compared to fresh build material.

Referring now to FIG. 2, there is shown a schematic diagram of a 3D printing system 200 according to one example. It will be appreciated that not all elements of a complete 3D printing system are shown.

The 3D printing system 200 comprises a build module 202 in which a 3D object may be generated. In some examples the build module 202 is removable from the 3D printing system 200, for example to enable the build module 202 to be removed from the 3D printing system 200 and transported to an external processing unit (not shown). An external processing unit may, for example, be used to separate a generated 3D object from unsolidified build material, and may, in some examples, prepare a mix of fresh build material and unsolidified build material used in a previous 3D printing process to generate a build material mix suitable for use in subsequent 3D printing processes. The build material mix may thus be used to enable further 3D objects to be generated by the printing system 200.

The system 200 also comprises a build material distributor 204 to enable a layer of build material to be formed within the build module 202. The build material distributor 204 may comprise, for example, a wiper or a roller mechanism to form a substantially uniform layer of build material using build material from a build material supply (not shown).

The system 200 also comprises an agent distribution module 206 to distribute one or multiple agents onto a formed layer of build material. The agent distribution module 206 may, for example, comprise one or multiple printheads, such as thermal inkjet or piezo printheads, to print one or multiple kinds of agents. In one example the agents are in fluid form.

In one example the agent distribution module 206 comprises an array of printhead nozzles that span, or substantially span, the width of the build module 202, in a page-wide array configuration. In another example the agent distribution module 206 may comprise one or multiple printheads on a movable carriage that may scan across the width of the build module 202. In one example the agent distribution module 206 may be controllable to selectively distribute at least a coalescing agent onto a formed layer of build material. In another example the agent distribution module 206 may be controllable to selectively distribute, in addition to a coalescing agent, a marking agent, as described in greater detail below. Relative motion between the build module 202 and the agent distributor 206 enables agent to be distributed to any location on a formed layer of build material.

In one example, the system 200 also comprises an energy source 208 to apply energy to formed layers of build material, such that portions of those layers on which coalescing agent has been deposited may coalesce and solidify. In one example the energy source 200 may apply energy to the whole, or substantially the whole, surface of formed layers of build material. In one example, the energy source 200 is a fixed energy source, for example positioned above the build module, to apply a determined level of energy to formed layers of build material. In another example, the energy source 200 may be a movable energy source that is movable over the surface of formed layers of build material to apply energy thereto. In a further example the energy source 200 may comprise a fixed and a movable energy source. In other examples the energy source 208 may not be present.

The system 200 further comprises a 3D printing system controller 210 to control the operation of the 3D printing system 200. The controller 210 comprises a processor 212 coupled to a memory 214. The memory 214 stores printer control computer readable instructions 216 that, when executed by the processor 212, control the general operation of the 3D printing system 200. The memory 214 further stores unsolidified build material marking computer readable instructions 218 that, when executed by the processor 212, control elements of the 3D printing system to mark unsolidified build material in accordance with examples described herein.

Operation of the 3D printing system 200, according to one example, will now be described with additional reference to the flow diagram of FIG. 3.

At 302, the controller 210 controls the 3D printing system 200 to generate a volume V_{S} of solidified build material within a build volume V_{BUILD}. The volume V_{S} of solidified build material may be generated in accordance with 3D printing data representing a model of one or multiple 3D objects to be generated within the build volume 100. The 3D printing data may, for example, define which portions of layers of build material are to be solidified, for example, in accordance with slices of a 3D object model. In one example the volume of solidified build material may comprise the generated 3D object. In another example, the volume of solidified build material may comprise additional volumes of solidified build material that are solidified during the generation of the 3D object. Such additional volumes may include, for example, so-called sacrificial parts which are generated to assist in the generation of a 3D object. Such sacrificial parts may include, for example: ‘heat reservoirs’ added to control thermal characteristics of the 3D object being generated; parts added to provide structural support to the 3D object being generated; and parts added to provide adhesion to a support platform of a build module.

At 304, the controller 210 controls the 3D printing system 200 to apply a marking agent to a predetermined portion of volume V_{US} of unsolidified build material. The marking agent may be any suitable agent that may be deposited applied to a volume of build material that enables presence of the applied marking agent to be subsequently detected. In one example, the marking agent may be a coloured agent, such as a coloured printing fluid, such as an ink or a dye. In another example, the marking agent may be marking agent that is not visible within the visible light spectrum, such as a marking agent that is visible when viewed under ultra-violet light. In other examples the marking agent may be any other suitable agent that enables its presence to be suitably detected, for example using optical or other techniques.

The deposition of marking agent on build material should not cause that build material to coalesce and solidify when energy is applied thereto. The marking agent should also not unduly affect the properties of the build material on which it is deposited. For example, build material on which marking agent has been applied remains solidifiable when used in a 3D printing process as described above. Furthermore, the marking agent should not unduly modify the form of build material on which it is applied. For example, powdered build material on which marking agent has been applied should remain in a powder form.

In another example the marking agent may be the same coalescing agent that is used to cause coalescence and solidification of build material as described above. However, if coalescing agent is used as the marking agent then it has to be deposited with a low-enough coverage density that it does not cause build material on which it has been deposited to absorb sufficient energy to cause coalescence and solidification of build material. Depending on the nature of the coalescing agent and the build material, a suitable coverage density for applying coalescing agent as a marking agent may be a coverage density of less than about 5%. In one example a coverage density of between about 0.5% and 4% may be chosen. This coverage density is lower than the coverage density at which coalescing agent is applied to cause coalescence and solidification when energy is applied thereto.

In another example the marking agent may be another agent used in a 3D printing process, such as a coalescence modifier agent. However, if a coalescence modifier agent is used as the marking agent then it has to be deposited with a low-enough coverage density that it will not prevent build material on which it has been deposited from being solidifiable when reused in subsequent 3D printing processes.

Although FIG. 3 shows block 304 following block 302, in one example blocks may be performed in parallel. For example, the controller 210 may control the 3D printing system 200 to deposit, on a single layer of build material, both coalescing agent and marking agent in respective patterns.

The marking agent may be applied to the predetermined portion of volume V_{US} in accordance with a marking agent deposition strategy. Example marking agent deposition strategies are described below in greater detail.

Whatever marking agent deposition strategy chosen, once a 3D printing process has completed, the build volume V_{BUILD} comprises a volume V_{S} of solidified build material and a volume V_{US} of unsolidified build material. The volume V_{US} of unsolidified build material further comprises a volume V_{US}_{_}_{M} of marked unsolidified build material.

In one example, about 1% to 10% of the volume V_{US} of unsolidified build material may be marked with marking agent. In other examples, a greater or lesser percentage of the volume V_{US} of unsolidified build material may be marked with marking agent.

Depending on the characteristics of the 3D printing system used, when marking agent is applied to a portion of a layer of build material the marking agent penetrates into the layer of build material. In some examples, the marking agent may mark penetrate substantially completely into the layer, and may hence mark 100% of the build material within the layer of the portion to which it is applied. In other examples, the marking agent may penetrate to a lesser degree, and may hence only mark about 50%, or some other percentage, of the build material within the layer of the portion to which it is applied. For example, this may depend on criteria such as the thickness of the layer of build material, the amount of marking agent applied, and the nature of the agent. The amount of the layer of build material marked by marking agent may be taken into account when determining the amount of unsolidified build material to be marked.

The build volume V_{BUILD} may then be transferred to a suitable post-processing module (not shown) to separate the solidified build material from the unsolidified build material. This may be performed in various manners, for example, by sieving the build volume V_{BUILD}, for example in addition to using vibrations, high-pressure air, or any other suitable process.

The volume V_{US} of unsolidified build material may then be mixed together using any appropriate mixing process, such as a rotative mixing process, a mechanical mixing process using rotating paddles, and so on.

The result of the mixing process is a substantially homogeneous mix 402 of unmarked and marked unsolidified build material, as illustrated in FIG. 4. Accordingly, the volume V_{US}_{_}_{M} of marked unsolidified build material will be substantially evenly distributed through the volume V_{US} of unsolidified build material. Consequently, the volume V_{US}_{_}_{M} of marked unsolidified build material within the volume V_{US} of unsolidified build material may be determined by determining the proportion of marked unsolidified build material within any portion of the volume V_{US} of unsolidified build material. By inference, the ‘freshness’ of the volume V_{US} of unsolidified build material may be determined.

For example, if the volume V_{US}=1.0 m³, and the volume V_{US}_{_}_{M} is 5% of V_{US} (i.e. 0.05 m³) then, once sufficiently mixed together, any volume of build material mix 402 will comprise 5% of marked build material, and 95% of unmarked build material, irrespective of the manner in which the marking agent is applied.

A post-processing module (not shown) can thus determine the proportion of marked unsolidified build material within the volume V_{US} of unsolidified build material by using suitable analysis techniques. For example, if the marking agent is a colored ink, the proportion of marking agent within any volume of unsolidified build material may be determined based on the average color of that volume. This may be determined, for example, using a spectrophotometer.

A post-processing module may thus determine an amount of a different build material to be mixed with the unsolidified build material such that the proportion of previously used unsolidified build material is below a predetermined threshold. The predetermined threshold level may be determined, for example, for a given build material and a given 3D printing process, for example based on appropriate testing and experiments. For example, it may be determined that using build material that has a percentage of previously used unsolidified build material above a predetermined threshold results in generated 3D objects having undesirable properties.

To enable the post-processing module to determine an amount of fresh build material to be mixed with the unsolidified build material the post-processing module has to know what proportion of the unsolidified build material was marked with a marking agent during a 3D printing process. In one example, this information may be manually entered into a suitable user interface of the post-processing module by a user. In another example, the 3D printing system 200 may record this information in a suitable memory device connected to, or associated with, the build module 202. In another example, the 3D printing system 200 may record this information in a data file along with a build module identifier, to enable the post-processing module to subsequently retrieve the stored information.

A more detailed operation of the 3D printing system 200 is now described with reference to the flow diagram of FIG. 5.

At 502, the controller 210 determines the build volume V_{BUILD} that is to be used during a 3D printing operation. In one example V_{BUILD} may be the volume of the build module 202. In another example V_{BUILD} may be a volume smaller than the volume of the build module 202, for example based on the number of layers of build material that are to be processed to generate a given 3D object or objects.

At 504, the controller 210 determines the volume V_{S} of build material to be solidified during a 3D printing operation. As previously described, V_{S} may comprise the volume of a 3D object to be generated, and may, in some examples, additionally comprise sacrificial parts. The volume V_{S} may be determined, for example, from data representing the 3D object to be built and, if appropriate, from sacrificial part data generated by the 3D printing system 200.

At 506, the controller 210 determines the volume V_{RUS} of recoverable build material that is not to be solidified. By recoverable is meant unsolidified build material that may be recovered by a suitable post-processing process or by a suitable processing module. For example, if the 3D object to be generated is a solid object, the amount of recoverable unsolidified build material will be V_{BUILD}−V_{S}. However, if the 3D object to be generated encloses a volume of unsolidified build material, then this volume of unsolidified build material may not be recoverable by a post-processing module. This may arise, for instance, during the construction of objects such as a ‘hollow’ ball, the interior of which will be filled with unsolidified build material that may not be recoverable by a post-processing module. The controller 210 may determine whether unsolidified build material may be not recoverable using appropriate geometric analysis of object model data, or printer control data. In one example the determination of the volume V_{RUS} of recoverable build material may additionally comprise identifying in 3D space within the build volume V_{BUILD} the position and size of the volume V_{RUS}.

At 508, the controller 210 determines the percentage of volume V_{RUS} of recoverable build material that is to be marked with marking agent. In one example this is determined based on a predetermined percentage of recoverable build material that is to be marked. In one example, the predetermined percentage of recoverable build material that is to be marked is 5%, although in other examples a higher or lower amount may be set.

At 510, the controller 210 controls the 3D printing system 200 to process successive layers of build material to solidify the volume V_{S} of build material in accordance with the 3D object being generated, and to apply marking agent to a volume V_{M} of recoverable build material according to a marking agent deposition strategy. In one example the marking agent is applied to portions of V_{BUILD} identified as being volumes comprising recoverable build material.

According to one marking agent deposition strategy, the marking agent may be applied to a single volume of build material, as illustrated in FIG. 6a. The marking agent may be applied to the single volume as one or multiple layers of build material are formed and are processed by the 3D printing system 200. For example, if the marking agent is applied to a polyhedron 602 of build material, a portion of that marking agent may be applied to one or multiple layers of build material that make up that polyhedron. In one example the shape of the volume of build material to which marking agent is applied is of little significance.

According to a further marking agent deposition strategy, the marking agent may be applied to multiple volumes 602a and 602b of build material, as illustrated in FIG. 6b.

According to a further marking agent deposition strategy, the marking agent may be applied in a substantially even distribution throughout the volume V_{RUS}of recoverable unsolidified build material. For example, the controller 210 may determine the average coverage density at which the determined volume of recoverable build material is to be marked with marking agent, and may therefore determine a suitable pattern, at the determined coverage density, at which to apply marking agent to each layer of build material.

If the marking agent is applied at too high a coverage density, this may, in some situations, cause an undesired cooling of build material. This in turn could cause portions to be solidified in proximity thereto to coalesce insufficiently which could lead to object quality issues. Accordingly, in a further marking agent deposition strategy, the marking agent is applied in a coverage density that is unlikely to cause any unwanted cooling effects of build material.

According to a further marking agent deposition strategy, the marking agent may be used to cool specific portions of build material, for example, if the controller determines that a portion of a layer of build material is overheated compared to other portions of a layer of build material. For example, in this way, the marking agent may be used as a cooling agent to help maintain a layer of build material at a desired temperature profile. In this example, the temperature of a layer of build material may be determined using a thermal imaging camera, or other suitable temperature sensing device or devices.

The marking agent may be deposited by one or multiple printheads in the agent distribution module 206. In one example, the agent distribution module 206 comprises a page-wide array of printheads or printhead nozzles for depositing the marking agent on appropriate portions of a layer of build material. In another example the agent distribution module 206 comprises a scanning printhead module for depositing the marking agent on appropriate portions of a layer of build material.

If, as previously mentioned, the marking agent is the coalescing agent, then a further marking agent deposition strategy may be used to help maintain agent distributor nozzles in the agent distribution module 206 in a healthy state, as illustrated in FIG. 7. FIG. 7 shows a plan view illustration of a portion of the 3D printing system 200 according to one example. An agent distribution module 206 is shown that comprises an array of nozzles 702a to 702n through which coalescing agent may be selectively ejected, under control of the controller 210. The agent distribution module 206 is controlled, by controller 210, to deposit drops of coalescing agent on a formed layer of build material 106n such that, after the application of energy, a portion 102 of solidified build material is formed and a portion 104 of unsolidified build material remains. As can be seen, a set of nozzles 704b are used to deposit coalescing agent to form the portion of to-be-solidified build material 102, whereas sets of nozzles 704a and 704c are not used. If sets of nozzles 704a and 704c are not used for some time, they may become partially or completely blocked, for example if coalescing agent at the nozzle dries or if airborne build material introduces itself inside a nozzle. Accordingly, the controller 210 may identify a nozzle or set of nozzles that may be subject to becoming unhealthy, and may control those nozzles to apply coalescing agent as a marking agent, as previously described. As previously mentioned, a coalescing agent may be used as a marking agent if deposited at a sufficiently low density that build material on which it is deposited is unable to absorb sufficient energy to coalesce and solidify. In one example, a suitable density may be between about 0.5% and 4%.

In a further example, a further marking agent deposition strategy may be used to help maintain agent distributor nozzles in the agent distribution module 206 in a healthy state, for example by causing the controller 210 to deposit drops of coalescence agent as a marking agent to perform preventative maintenance operations such as nozzle spitting.

In some examples the build material may be a powder-based build material. As used herein the term powder-based materials is intended to encompass both dry and wet powder-based materials, particulate materials, and granular materials. In some examples, the build material may include a mixture of air and solid polymer particles, for example at a ratio of about 40% air and about 60% solid polymer particles. One suitable material may be Nylon 12, which is available, for example, from Sigma-Aldrich Co. LLC. Another suitable Nylon 12 material may be PA 2200 which is available from Electro Optical Systems EOS GmbH. Other examples of suitable build materials may include, for example, powdered metal materials, powdered composite materials, powdered ceramic materials, powdered glass materials, powdered resin material, powdered polymer materials, and the like, and combinations thereof. It should be understood, however, that the examples described herein are not limited to powder-based materials or to any of the materials listed above. In other examples the build material may be in the form of a paste, liquid or a gel. According to one example a suitable build material may be a powdered semi-crystalline thermoplastic material.

According to one non-limiting example, a suitable coalescing agent may be an ink-type formulation comprising carbon black, such as, for example, the ink formulation commercially known as CM997A available from Hewlett-Packard Company. In one example such an ink may additionally comprise an infra-red light absorber. In one example such an ink may additionally comprise a near infra-red light absorber. In one example such an ink may additionally comprise a visible light absorber. In one example such an ink may additionally comprise a UV light absorber. Examples of inks comprising visible light enhancers are dye based colored ink and pigment based colored ink, such as inks commercially known as CM993A and CE042A available from Hewlett-Packard Company.

It will be appreciated that examples described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, examples described herein provide a program comprising code for implementing a system or method as claimed in any preceding claim and a machine readable storage storing such a program.

All of the features disclosed in this specification (including any accompanying claims, abstract and drawings), and/or all of the blocks of any method or process so disclosed, may be combined in any combination, except combinations where at least some of such features and/or blocks are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A method of 3D printing, comprising:
generating, within a build volume of build material, a volume of solidified build material; and
marking a predetermined portion of unsolidified build material within the build volume with a marking agent.

2. The method of claim 1, wherein marking a portion of unsolidified build material comprises applying a marking agent to a portion of unsolidified build material recoverable in a post-processing operation.

3. The method of claim 1, wherein marking a predetermined portion of the unsolidified build material is to enable the unsolidified build material to be identifiable as having been previously present during the generation of a volume of solidified build material.

4. The method of claim 1, wherein the volume of solidified build material is generated on a layer-by-layer basis by repeatedly forming a layer of build material, printing a pattern of a coalescent agent on a formed layer of build material, and applying energy to at least a portion of the layer of build material to cause build material on which coalescent agent has been applied to coalesce and solidify.

5. The method of claim 4, wherein marking a predetermined portion of the unsolidified build material within the build volume comprises marking with the coalescing marking agent at a coverage density that does not cause build material to which it is applied to coalesce and solidify.

6. The method of claim 4, wherein marking a predetermined portion of the unsolidified build material within the build volume comprises marking with an agent different to the coalescing marking agent.

7. The method of claim 1, further comprising:
determining a build volume;
determining a volume of build material within the build volume to be solidified;
determining a volume of unsolidified build material recoverable from the build volume;
determining a volume of the recoverable build material to be marked; and
marking, during a 3D printing process, the determined volume of recoverable build material.

8. The method of claim 1, wherein marking a predetermined portion of the unsolidified build material is performed in accordance with a predetermined marking strategy to help maintain an agent distribution device in a healthy state.

9. The method of claim 1, wherein marking a predetermined portion of the unsolidified build material V_{US} within the build volume comprises marking about 1% to 10% of the unsolidified build material.

10. An additive manufacturing system for generating 3D objects, comprising:
a build material distributor to form layers of build material on a support of a build module;
an agent distribution module to distribute an agent onto a formed layer of build material; and
a controller to:
control the additive manufacturing system to solidify build material in accordance with 3D printing data representing a model of a 3D object to be generated within a build volume; and
control the agent distribution module to mark a predetermined portion of the build material not to be solidified.

11. The system of claim 10, wherein the agent distribution module is to distribute a coalescing agent onto a formed layer of build material such that, when energy is applied thereto, portions of the build material on which the coalescing agent is applied coalesce and solidify; and
wherein the controller is to control the agent distribution module to mark the predetermined portion of the build material with the coalescing agent at a lower coverage density that, when energy is applied thereto, does not cause portions of the build material on which the coalescing agent is applied at lower density to coalesce and solidify.

12. The system of claim 10, wherein the controller is to control the agent distribution module to mark the predetermined portion of the build material with the coalescing agent at a coverage density in the range of about 0.5% to 4%.

13. The system of claim 10, further comprising an agent distribution module to distribute a marking agent onto a formed layer of build material, and wherein the controller is to control the marking agent distribution module to mark the predetermined portion of the build material with the marking agent.

14. The system of claim 10, wherein the controller is control the agent distribution module to mark a predetermined portion of unsolidified build material that is recoverable from the build volume after a 3D object has been generated therein.

15. A non-transitory computer readable storage medium encoded with instructions, executable by a processor, comprising:
instructions to control an additive manufacturing system to generate a 3D object within an build volume of build material; and
instructions to control the additive manufacturing system to apply a marking agent to a predetermined portion of recoverable unsolidified build material within the build volume.
